(19) United States
(12) Patent Application Publication
(10) Pub. No.: US 2023/0048649 A1
(43) Pub. Date: Feb. 16, 2023

(54) METHOD OF PROCESSING IMAGE, ELECTRONIC DEVICE, AND MEDIUM

(71) Applicant: Apollo Intelligent Connectivity (Beijing) Technology Co., Ltd., Beijing (CN)

(72) Inventors: Xiaoyun WANG, Beijing (CN); Mingzhi CHEN, Beijing (CN); Zhao WANG, Beijing (CN)

(21) Appl. No.: 17/973,755

(22) Filed: Oct. 26, 2022

(30) Foreign Application Priority Data
Oct. 27, 2021 (CN) 202111259230.6

(51) Int. Cl. G06T 5/00; G06T 7/00; G06T 5/20; G06T 5/50

(52) U.S. Cl. CPC G06T 5/002; G06T 5/20; G06T 5/50; G06T 7/0002; G06T 2207/20032; G06T 2207/30168

(57) ABSTRACT

The present disclosure provides a method of processing an image, a device, and a medium. The method of processing the image includes: performing a noise reduction on an original image to obtain a smooth image; performing a feature extraction on the original image to obtain feature data for at least one direction; and determining an image quality of the original image according to the original image, the smooth image, and the feature data for the at least one direction.

### CROSS-REFERENCE TO RELATED APPLICATION(S

This application claims the priority of Chinese Patent Application No. 202111259230.6, filed on Oct. 27, 2021, the entire contents of which are hereby incorporated by reference.

### TECHNICAL FIELD

The present disclosure relates to a field of an artificial intelligence technology, in particular to fields of autonomous driving, intelligent transportation, computer vision and deep learning technologies. More specifically, the present disclosure relates to a method of processing an image, an electronic device, and a medium.

### BACKGROUND

In some scenarios, an image recognition needs to be performed on an acquired image to determine an image quality of the acquired image. For example, in a field of traffic, an image of traffic may be captured by a camera, so that a traffic condition may be determined according to the image. However, in a related art, when recognizing an image quality of an image, an effect of recognition is not good, and the recognition is costly.

### SUMMARY

The present disclosure provides a method of processing an image, an electronic device, and a storage medium.

According to an aspect of the present disclosure, a method of processing an image is provided, including: performing a noise reduction on an original image to obtain a smooth image; performing a feature extraction on the original image to obtain feature data for at least one direction; and determining an image quality of the original image according to the original image, the smooth image, and the feature data for the at least one direction.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of processing the image as described above.

According to another aspect of the present disclosure, a non-transitory computer-readable storage medium having computer instructions therein is provided, and the computer instructions are configured to cause a computer to implement the method of processing the image as described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure.

FIG. 1 schematically shows an application scenario of a method and an apparatus of processing an image according to embodiments of the present disclosure.

FIG. 2 schematically shows a flowchart of a method of processing an image according to embodiments of the present disclosure.

FIG. 3 schematically shows a method of processing an image according to embodiments of the present disclosure.

FIG. 4 schematically shows a convolution calculation according to embodiments of the present disclosure.

FIG. 5 schematically shows a schematic diagram of a feature image according to embodiments of the present disclosure.

FIG. 6 schematically shows a system architecture of a method of processing an image according to embodiments of the present disclosure.

FIG. 7 schematically shows a schematic diagram of a method of processing an image according to embodiments of the present disclosure.

FIG. 8 schematically shows a sequence diagram of a method of processing an image according to embodiments of the present disclosure.

FIG. 9 schematically shows a block diagram of an apparatus of processing an image according to embodiments of the present disclosure.

FIG. 10 shows a block diagram of an electronic device for performing an image processing for implementing embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

The terms used herein are for the purpose of describing specific embodiments only and are not intended to limit the present disclosure. The terms “comprising”, “including”, “containing”, etc. used herein indicate the presence of the feature, step, operation and/or part, but do not exclude the presence or addition of one or more other features, steps, operations or parts.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or too rigid way.

In a case of using the expression similar to “at least one of A, B and C”, it should be explained according to the meaning of the expression generally understood by those skilled in the art (for example, “a system including at least one of A, B and C” should include but not be limited to a system including only A, a system including only B, a system including only C, a system including A and B, a system including A and C, a system including B and C, and/or a system including A, B and C).

Embodiments of the present disclosure provide a method of processing an image, including: performing a noise reduction on an original image to obtain a smooth image; performing a feature extraction on the original image to obtain feature data for at least one direction; and determining an image quality of the original image according to the original image, the smooth image, and the feature data for the at least one direction..

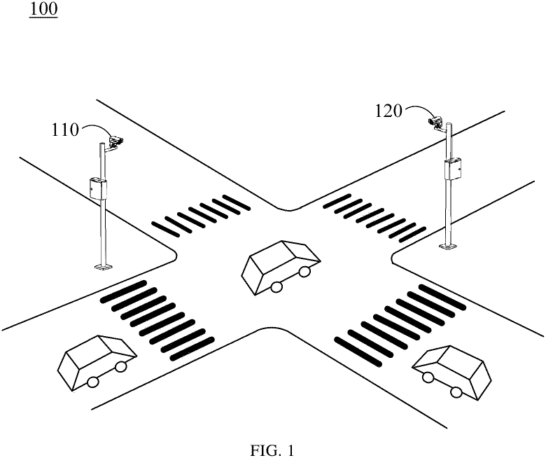

FIG. 1 schematically shows an application scenario of a method and an apparatus of processing an image according to embodiments of the present disclosure. It should be noted that FIG. 1 is only an example of the application scenario to which embodiments of the present disclosure may be applied to help those skilled in the art understand the technical content of the present disclosure, but it does not mean that embodiments of the present disclosure may not be applied to other devices, systems, environments or scenarios.

As shown in FIG. 1, an application scenario 100 of the present disclosure includes, for example, a plurality of cameras 110 and 120.

The plurality of cameras 110 and 120 may be used to, for example, capture video streams. A traffic condition may be obtained by identifying image frames in the video streams. The plurality of cameras 110 and 120 may be installed on a road device, or may be installed on an autonomous driving vehicle to capture video streams in real time during a driving process of the autonomous driving vehicle.

In some scenarios, due to various external environmental reasons, such as wind, rain, freezing, etc., the video stream captured by the camera may be abnormal. For example, an image frame in the video stream may have noise points, blurring, occlusion, color deviation or brightness abnormality, etc., which may result in a poor image quality. When the recognition is performed based on a video stream with a poor image quality, it is difficult to accurately identify vehicles, license plates, pedestrians, and other traffic conditions at intersections.

Embodiments of the present disclosure may be implemented to determine the image quality by means of image recognition, so as to timely detect whether the camera is abnormal according to the image quality. Different from detecting an abnormal shooting of the camera by means of manual inspection, embodiments of the present disclosure may reduce a maintenance cost of the camera.

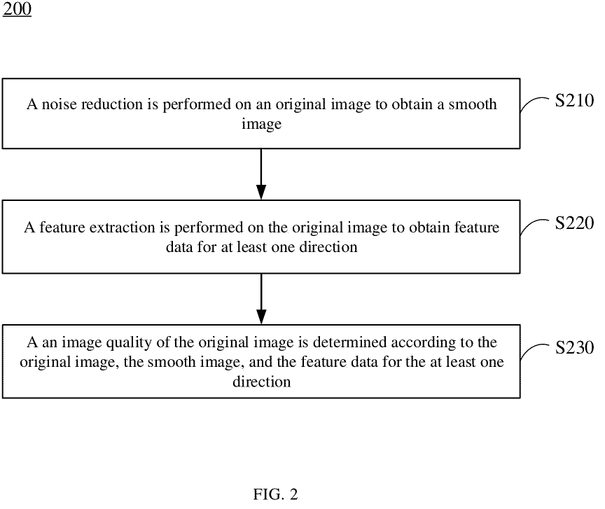

Embodiments of the present disclosure provide a method of processing an image. The method of processing the image according to exemplary embodiments of the present disclosure will be described below with reference to FIG. 2 to FIG. 8 in combination with the application scenario of FIG. 1.

FIG. 2 schematically shows a flowchart of a method of processing an image according to embodiments of the present disclosure.

As shown in FIG. 2, a method 200 of processing an image of embodiments of the present disclosure may include, for example, operation S210 to operation S230.

In operation S210, a noise reduction is performed on an original image to obtain a smooth image.

In operation S220, a feature extraction is performed on the original image to obtain feature data for at least one direction.

In operation S230, an image quality of the original image is determined according to the original image, the smooth image, and the feature data for the at least one direction.

Exemplarily, the original image may be, for example, an image frame in a video stream captured by a camera. The original image has noise points as the camera is affected by an external environment. Therefore, the image quality of the original image needs to be determined by determining a noise point information in the original image.

For example, a noise reduction may be performed on the original image to obtain a smooth image, in which a noise point information, for example, may be removed. However, in the smooth image, some edge information in the original image is also inevitably removed.

Then, a feature extraction may be performed on the original image to obtain feature data for a plurality of directions. The plurality of directions may include, for example, a horizontal direction, a vertical direction, an oblique direction, and so on for the original image. The feature data may represent, for example, the noise information in the original image.

Next, the image quality of the original image may be determined according to the original image, the smooth image, and the feature data for the at least one direction, for example, according to a comparison result between the original image and the smooth image, which may include, for example, the noise point information and the edge information in the original image. As the feature data for the at least one direction represents the noise point information in the original image, the noise point information may be determined from the comparison result between the original image and the smooth image, with the feature data for the at least one direction as a reference, and the image quality of the original image may be determined according to the noise point information.

According to embodiments of the present disclosure, a noise reduction is performed on the original image to obtain a smooth image, and feature data for at least one direction of the original image is extracted, then the image quality of the original image may be obtained according to the original image, the smooth image, and the feature data for the at least one direction. In this way, an effect and an accuracy of a detection of the image quality may be improved, and a detection cost may be reduced.

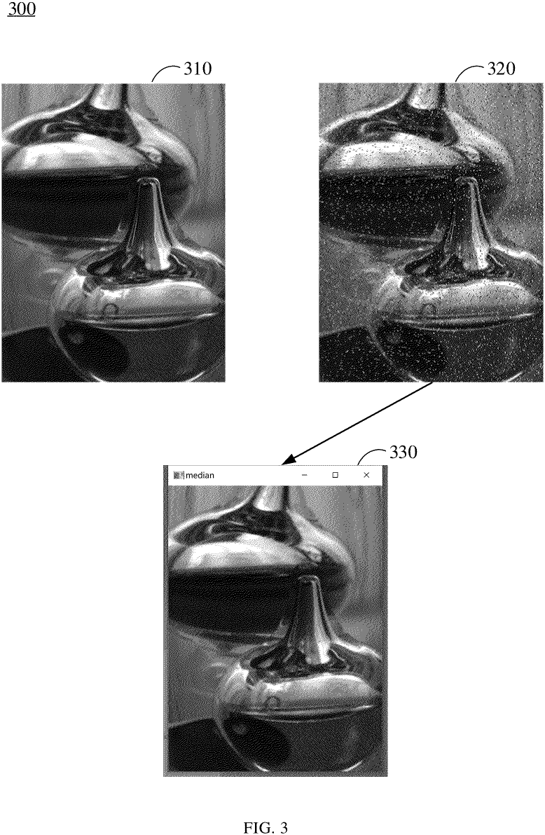

FIG. 3 schematically shows a schematic diagram of a method of processing an image according to embodiments of the present disclosure.

As shown in FIG. 3, when there is no abnormality in the camera that captures the image, the captured image is a normal image 310, which may, for example, contain no noise points or a small number of noise points.

When there is an abnormality in the camera that captures the image, the captured image may contain, for example, a plurality of noise points. When the captured image is converted into a gray scale image to obtain an original image 320, the original image 320 may contain a plurality of noise points.

A noise in the original image 320 may be a salt and pepper noise, also known as an impulse noise, which is a common noise in images. The salt and pepper noise is randomly appearing white point or black point, which may be a black pixel in a bright region or a white pixel in a dark region (or both). The salt and pepper noise may be caused by a sudden strong interference to an image signal, or by an error in an analog to digital converter or a bit transmission.

Exemplarily, when the noise reduction is performed on the original image 320, a median filter may be used to perform a filtering on the original image 320 to obtain a smooth image 330. A filtering process of the median filter is performed to replace a pixel value of a pixel with a median value of an intensity value in a neighborhood of that pixel (the pixel value of that pixel may also be included in a process of calculating the median value). The median filter may provide a good noise reduction performance in dealing with the salt and pepper noise.

However, when the filtering is performed using the median filter, an edge of the image may be blurred and less sharp, because the pixel value is replaced by the median value and a portion such as a boundary or details may be blurred if the pixel value varies greatly. Therefore, in the smooth image 330 obtained by filtering, the noise point is removed, and an information on an image edge is also removed.

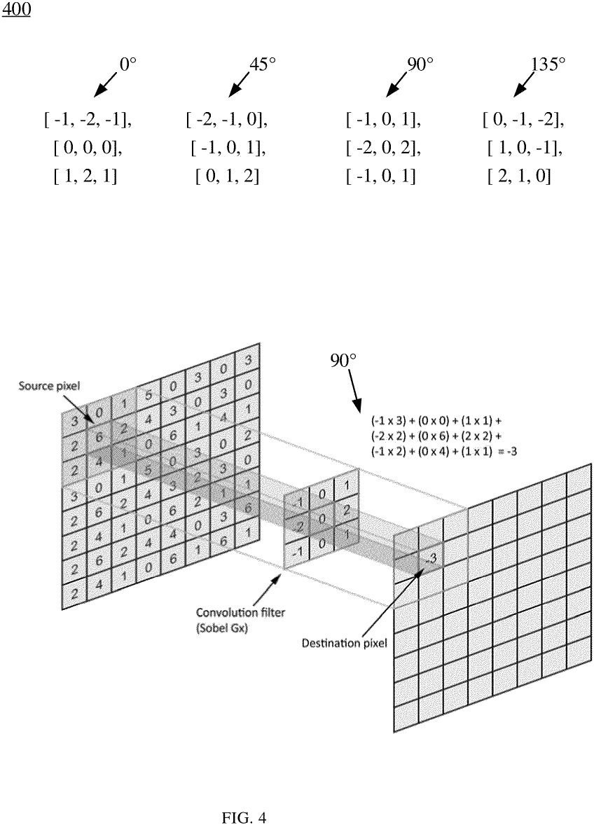

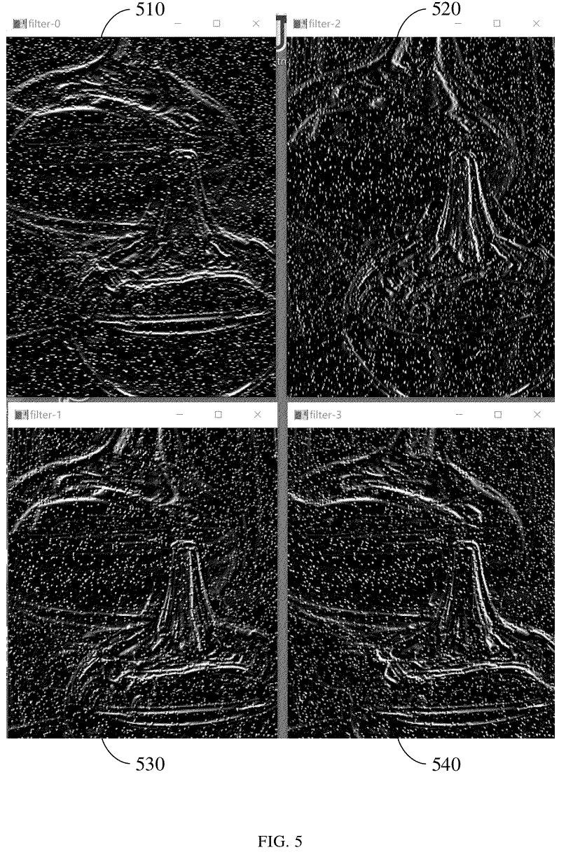

When the smooth image 330 is obtained, the original image 320 may be compared with the smooth image 330 to obtain a comparison result. The comparison result may include, for example, a noise point information and an edge information of the original image. Therefore, a feature extraction needs to be performed on the original image 320 to obtain the noise point information, so that a noise information may be determined from the comparison result by using the noise point information obtained by the feature extraction as a reference. For a process of the feature extraction, reference may be made to, for example, FIG. 4 and FIG. 5.

FIG. 4 schematically shows a convolution calculation according to embodiments of the present disclosure.

As shown in FIG. 4, an embodiment 400 of the present disclosure includes, for example, a convolution calculation of the original image. For example, a convolution calculation may be performed on the original image data respectively using at least one convolution kernel one-to-one corresponding to at least one direction, so as to obtain feature data for the at least one direction.

Taking four directions as an example, the four directions may include, for example, 0° direction, 45° direction, 90° direction, and 135° direction. Four convolution kernels corresponding to the four directions are shown in FIG. 4. Each convolution kernel is, for example, a 3*3 matrix.

The convolution calculation is performed on the original image respectively using each of the four convolution kernels, and four feature data one-to-one corresponding to the four convolution kernels may be obtained. The four feature data may be, for example, four feature images. FIG. 4 shows the convolution of the original image with the convolution kernel corresponding to the 90° direction.

FIG. 5 schematically shows a schematic diagram of a feature image according to embodiments of the present disclosure.

As shown in FIG. 5, a convolution is performed on the original image respectively using the convolution kernels corresponding to the four directions, so as to obtain feature data for the four directions, which may include, for example, four feature images 510, 520, 530, 540.

When the smooth image and the feature data for the plurality of directions are obtained, it is possible to determine, for a current pixel in the original image, a pixel difference value between the current pixel and a corresponding pixel in the smooth image, for example, to subtract a pixel value of the pixel corresponding to the current pixel in the smooth image from a pixel value of the current pixel in the original image. Specifically, each pixel in the original image may be taken as the current pixel in turn.

Then, target feature data for the current pixel may be determined from the feature data for the at least one direction, and the image quality of the original image may be determined according to the pixel difference value and the target feature data.

For an acquisition of the target feature data, for example, when the feature data for the at least one direction includes feature images for a plurality of directions, a target feature image for one direction may be determined from the feature images for the plurality of directions, then a pixel value of a target pixel corresponding to the current pixel in the target feature image may be determined as the target feature data for the current pixel.

For example, a plurality of candidate pixels corresponding to the current pixel may be determined from the feature images for the plurality of directions, and the plurality of candidate pixels one-to-one correspond to the feature images for the plurality of directions. Taking feature images for four directions as an example, a pixel corresponding to the current pixel is determined from a first feature image as a first candidate pixel, a pixel corresponding to the current pixel is determined from a second feature image as a second candidate pixel, a pixel corresponding to the current pixel is determined from a third feature image as a third candidate pixel, and a pixel corresponding to the current pixel is determined from a fourth feature image as a fourth candidate pixel.

Next, a candidate pixel with a smallest pixel value is determined from the four candidate pixels, and the feature image corresponding to the candidate pixel with the smallest pixel value is determined as the target feature image. For example, if the second feature image is determined as the target feature image, a pixel value of the target pixel (the second candidate pixel) corresponding to the current pixel in the target feature image is determined as the target feature data for the current pixel.

Therefore, the target feature data is the pixel value of the target pixel. As mentioned above, the pixel difference value between the current pixel in the original image and the corresponding pixel in the smooth image may be obtained. If the pixel difference value is greater than a first threshold value and the pixel value of the target pixel is greater than a second threshold value, it may be determined that the current pixel is a noise point. The first threshold value includes, for example, but is not limited to 10, and the second threshold value includes, for example, but is not limited to 0.1.

It is possible to traverse each pixel in the original image as the current pixel to determine whether that pixel is a noise point. Then, the image quality of the original image may be determined according to a number of noise points of the original image.

For example, a ratio of the number of noise points of the original image to a total number of pixels of the original image may be determined, and then the image quality of the original image may be determined according to the ratio. When the ratio is greater than a predetermined ratio, it may be determined that the original image has a poor image quality, that is, the original image exhibits a large degree of salt and pepper noise.

According to embodiments of the present disclosure, a noise reduction is performed on the original image using the median filter so as to obtain a smooth image, and a feature extraction is performed on the original image using convolution kernels corresponding to a plurality of directions so as to obtain the feature data for the plurality of directions. Then, the noise points are initially determined according to the difference value between the original image and the smooth image, and the initially determined noise points may have, for example, a false information. Next, with the feature data for the plurality of directions as a reference, real noise points may be determined from the initially determined noise points, and the image quality of the original image may be determined according to the ratio of the noise points to the original image. Through embodiments of the present disclosure, the effect and accuracy of the detection of the image quality may be improved, and the detection cost may be reduced.

In another example of the present disclosure, it is also possible to determine a level of blur, a level of color deviation, a level of brightness abnormality and other information of the original image, so as to determine the image quality of the original image. Exemplarily, embodiments of the present disclosure may be implemented to comprehensively determine the image quality of the original image according to the level of salt and pepper noise, the level of blur, the level of color deviation, and the level of brightness abnormality of the original image.

In an example, for the level of blur of the original image, a sharpness evaluation method without reference image may be used, and a square of a gray scale difference between two adjacent pixels may be calculate using a Brenner gradient function. For example, the Brenner gradient function may be defined as Equation (1).

$$D \left(f\right) = {\sum }_{y} {\sum }_{x} {\left|f \left(x + 2 , y\right) - f \left(x , y\right)\right|}^{2}$$

where f (x,y) represents a gray value of a pixel point (x, y) in an original image f, and D(f) represents a calculation result of a definition (variance) of the original image.

The variance D(f) is calculated for each pixel of the original image, so as to obtain a cumulative variance over all pixels. When the cumulative variance is less than a predetermined threshold, it is determined that the original image has a poor image quality, that is, the original image is blurry.

In another example, for the level of color deviation of the original image, when the original image is an RGB color image, the RGB color image may be converted to a CIE L*a*b* space, where L* represents a lightness of image, a* represents a red/green component of image, and b* represents a yellow/blue component of image. Generally, for an image with a color deviation, a mean value of a* component and a mean value of b* component may deviate far from an origin, and the variances thereof may also be small. Therefore, by calculating the mean values and variances for a* and b* components of the image, it is possible to evaluate whether the image has a color deviation according to the mean values and the variances.

$${\text{d}}_{a} = \frac{{\sum }_{i = 1}^{m} {\sum }_{j = 1}^{n} a}{m n} {\text{d}}_{b} = \frac{{\sum }_{i = 1}^{m} {\sum }_{i = 1}^{m} b}{m n}$$

$$D = \sqrt{{d}_{a}^{2} + {d}_{b}^{2}}$$

$${\text{M}}_{a} = \frac{{\sum }_{i = 1}^{m} {\sum }_{j = 1}^{n} \left(a - {\text{d}}_{a}\right)}{m n} {\text{M}}_{b} = \frac{{\sum }_{i = 1}^{m} {\sum }_{j = 1}^{n} \left(b - {\text{d}}_{b}\right)}{m n}$$

$$\text{M} = \sqrt{{M}_{a}^{2} + {M}_{b}^{2}}$$

$$\text{K} = D / M$$

where dₐ and d_{b} respectively represent the mean value of the a* component and the mean value of the b* component of the image, and Mₐ and M_{b} respectively represent the variance of the a* component and the variance of the b* component of the image.

In Equation (2) to Equation (6), m and n respectively represent a width and a height of the image, in pixels. On an a-b chromaticity plane, an equivalent circle has a center with coordinates (dₐ, d_{b}) and a radius M. A distance from the center of the equivalent circle to an origin of a neutral axis of the a-b chromaticity plane (a=0, b=0) is D. An overall color deviation of the image may be determined by a specific position of the equivalent circle on the a-b chromaticity plane. When dₐ> 0, the image tends to be red, otherwise the image tends to be green. When d_{b}> 0, the image tends to be yellow, otherwise the image tends to be blue. The greater the value of the color deviation factor K, the greater the level of color deviation of the image.

In another example, for the level of brightness abnormality of the original image, when the original image is a gray scale image, a mean value dₐ and a mean deviation Mₐ of the gray scale image may be calculated by Equation (7) to Equation (11). When the image has a brightness abnormality, the mean value may deviate from a mean point (the mean point may be, for example, 128), and the mean deviation may be small. By calculating the mean value and the mean deviation of the image, it is possible to evaluate whether the image is overexposed or underexposed according to the mean value and the mean deviation.

$${\text{d}}_{a} = \frac{{\sum }_{i = 0}^{N - 1} \left({x}_{i} - 128\right)}{N}$$

$$\text{D =} \left|{\text{d}}_{a}\right|$$

$${\text{M}}_{a} = \frac{{\sum }_{i = 0}^{255} \vert \left(i - 128\right) - {\text{d}}_{a} \vert \times \text{Hist} \left[i\right]}{N}$$

$$\text{M =} \left|{\text{M}}_{a}\right|$$

$$K = D / M$$

In Equation (7), xᵢ represents a pixel value of an i^{th} pixel in the original image, and N is the total number of pixels in the original image; Hist[i] in Equation (9) is a number of pixels having a pixel value i in the original image.

When a brightness factor K is less than a predetermined threshold, the image has a normal brightness. When the brightness factor is greater than or equal to the predetermined threshold, the image has an abnormal brightness. Specifically, the mean value dₐ may be further determined when the brightness factor is greater than or equal to the predetermined threshold. If the mean value dₐ is greater than 0, it indicates that the image brightness tends to be large, and if the mean value dₐ is less than or equal to 0, it indicates that the image brightness tends to be small.

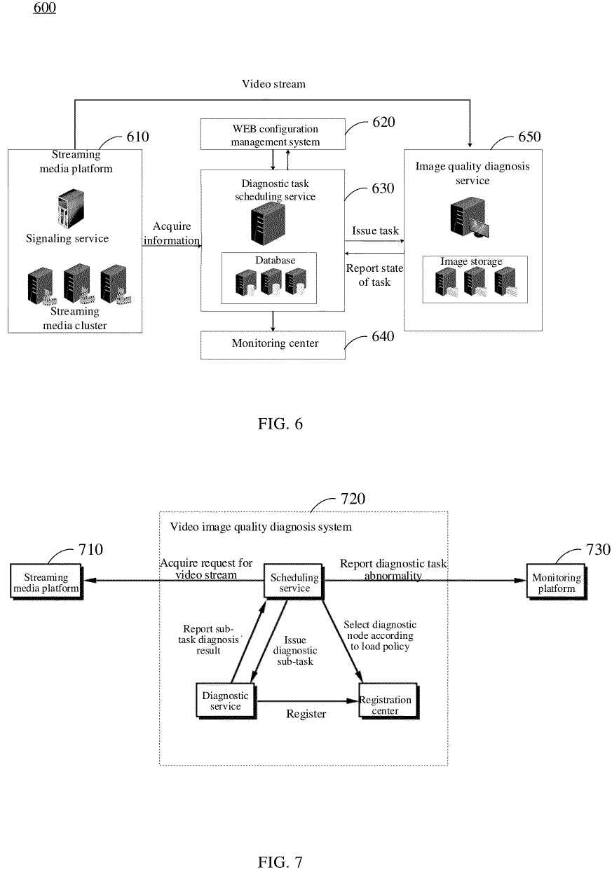

FIG. 6 schematically shows a system architecture of a method of processing an image according to embodiments of the present disclosure.

As shown in FIG. 6, a system architecture 600 of video image quality diagnosis includes, for example, a streaming media platform 610, a WEB configuration management system 620, a diagnostic task scheduling service 630, a monitoring center 640, and an image quality diagnosis service 650.

The streaming media platform 610 may include, for example, a signaling service and a streaming media cluster. The streaming media platform 610 is used to acquire a video stream that includes an image for diagnosis.

The WEB configuration management system 620 is used to manage a diagnostic task, which may include, for example, an image quality diagnosis of the image in the video stream.

The diagnostic task scheduling service 630 is used to schedule the diagnostic task. The diagnostic task scheduling service 630 may include a database for storing a task information.

The monitoring center 640 is used to monitor an execution of task in the diagnostic task scheduling service 630.

The image quality diagnosis service 650 is used to acquire a video stream from the streaming media platform 610 according to a task issued by the diagnostic task scheduling service 630, perform an image quality diagnosis on an image in the video stream, and report a state of a task execution to the diagnostic task scheduling service 630.

FIG. 7 schematically shows a method of processing an image according to embodiments of the present disclosure.

As shown in FIG. 7, embodiments according to the present disclosure may include, for example, a streaming media platform 710, a video image quality diagnosis system 720, and a monitoring platform 730.

The streaming media platform 710 is used to generate a video stream.

The video image quality diagnosis system 720 may include, for example, a scheduling service, a diagnostic service, and a registration center. The scheduling service may send a request to the streaming media platform 710 to acquire a video stream. The scheduling service may further issue a diagnostic sub-task to the diagnostic service. When the diagnostic sub-task is executed completely, the diagnostic service may report a sub-task diagnosis result to the scheduling service. The diagnostic service may be registered with the registration center. The scheduling service may further select a diagnosis node according to a load policy, so that the diagnostic sub-task may be issued according to the diagnosis node. The scheduling service may further report an abnormal diagnostic task to the monitoring platform 730.

The monitoring platform 730 is used to monitor a state of the diagnostic task.

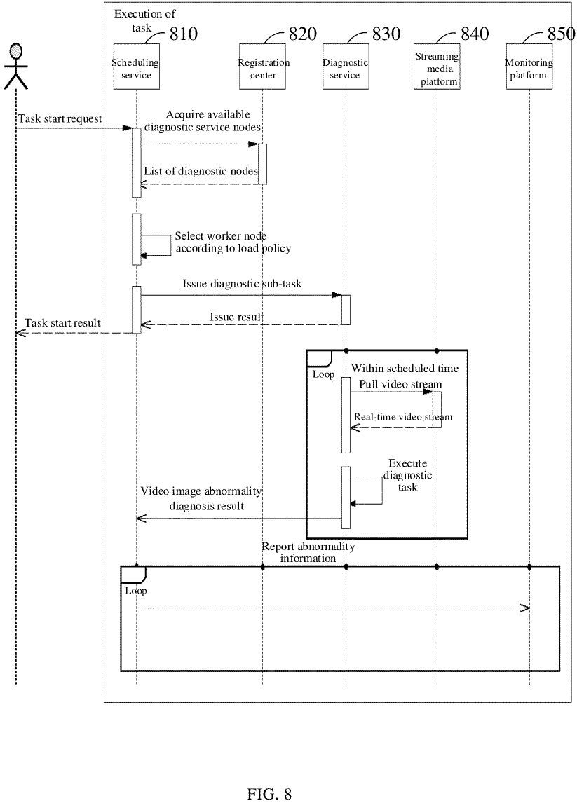

FIG. 8 schematically shows a sequence diagram of a method of processing an image according to embodiments of the present disclosure.

As shown in FIG. 8, embodiments according to the present disclosure may include, for example, a scheduling service 810, a registration center 820, a diagnostic service 830, a streaming media platform 840, and a monitoring platform 850.

When receiving a task start request from a user, the scheduling service 810 acquires available diagnostic service nodes from the registration center 820. The registration center 820 returns a list of diagnostic nodes to the scheduling service 810. The scheduling service 810 selects a worker node according to a load policy base on the list of nodes.

When the worker node is selected, the scheduling service 810 issues a diagnostic sub-task to the diagnostic service 830, and the diagnostic service 830 feeds back a result of issuing. When receiving the result of issuing, the scheduling service 810 feeds back a task start result to the user.

The diagnostic service 830 executes the diagnostic task in a loop within a scheduled time. For example, the diagnostic service 830 sends a request to the streaming media platform 840 to pull a video stream, the streaming media platform 840 returns a real-time video stream to the diagnostic service 830, and then the diagnostic service 830 executes an image quality diagnosis task according to the video stream, and returns a video image abnormality diagnosis result to the scheduling service 810.

When receiving the video image abnormality diagnosis result, the scheduling service 810 may report an abnormality information to the monitoring platform 850.

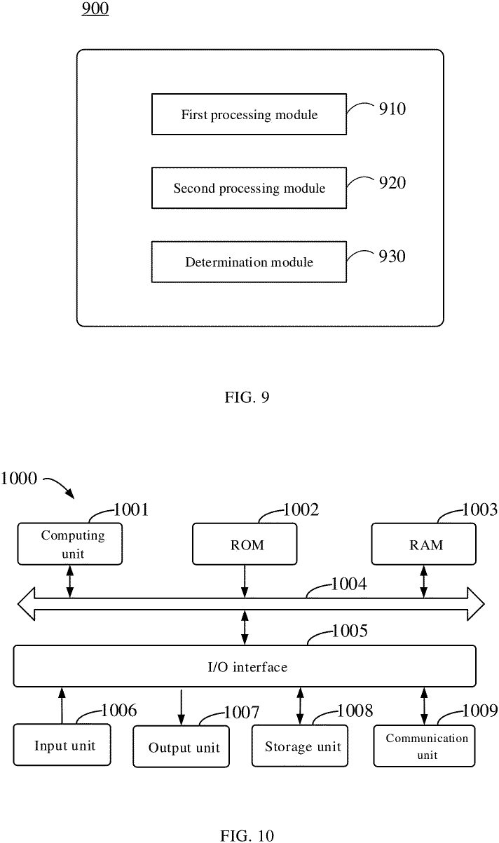

FIG. 9 schematically shows a block diagram of an apparatus of processing an image according to embodiments of the present disclosure.

As shown in FIG. 9, an apparatus 900 of processing an image of embodiments of the present disclosure includes, for example, a first processing module 910, a second processing module 920, and a determination module 930.

The first processing module 910 may be used to perform a noise reduction on an original image to obtain a smooth image. According to embodiments of the present disclosure, the first processing module 910 may perform, for example, the operation S210 described above with reference to FIG. 2, which will not be repeated here.

The second processing module 920 may be used to perform a feature extraction on the original image to obtain feature data for at least one direction. According to embodiments of the present disclosure, the second processing module 920 may perform, for example, the operation S220 described above with reference to FIG. 2, which will not be repeated here.

The determination module 930 may be used to determine an image quality of the original image according to the original image, the smooth image, and the feature data for the at least one direction. According to embodiments of the present disclosure, the determination module 930 may perform, for example, the operation S230 described above with reference to FIG. 2, which will not be repeated here.

According to embodiments of the present disclosure, the determination module 930 may include a first determination sub-module, a second determination sub-module, and a third determination sub-module. The first determination sub-module may be used to determine, for a current pixel in the original image, a pixel difference value between the current pixel and a corresponding pixel in the smooth image. The second determination sub-module may be used to determine target feature data for the current pixel from the feature data for the at least one direction. The third determination sub-module may be used to determine the image quality of the original image according to the pixel difference value and the target feature data.

According to embodiments of the present disclosure, the feature data for the at least one direction includes a plurality of feature images for a plurality of directions; and the second determination sub-module may include a first determination unit and a second determination unit. The first determination unit may be used to determine a target feature image for one direction from the plurality of feature images for the plurality of directions. The second determination unit may be used to determine a pixel value of a target pixel corresponding to the current pixel in the target feature image as the target feature data for the current pixel.

According to embodiments of the present disclosure, the first determination unit may include a first determination sub-unit, a second determination sub-unit, and a third determination sub-unit. The first determination sub-unit may be used to determine, from the plurality of feature images for the plurality of directions, a plurality of candidate pixels corresponding to the current pixel, and the plurality of candidate pixels one-to-one correspond to the plurality of feature images for the plurality of directions. The second determination sub-unit may be used to determine a candidate pixel with a smallest pixel value from the plurality of candidate pixels. The third determination sub-unit may be used to determine a feature image corresponding to the candidate pixel with the smallest pixel value as the target feature image.

According to embodiments of the present disclosure, the target feature data includes a pixel value of a target pixel; and the third determination sub-module includes a third determination unit and a fourth determination unit. The third determination unit may be used to determine the current pixel as a noise point, in response to determining that the pixel difference value is greater than a first threshold value and the pixel value of the target pixel is greater than a second threshold value. The fourth determination unit may be used to determine the image quality of the original image according to a number of noise points of the original image.

According to embodiments of the present disclosure, the fourth determination unit includes a fourth determination sub-unit and a fifth determination sub-unit. The fourth determination sub-unit may be used to determine a ratio of the number of noise points of the original image to a total number of pixels of the original image. The fifth determination sub-unit may be used to determine the image quality of the original image according to the ratio.

According to embodiments of the present disclosure, the second processing module 920 may be further used to: perform a convolution on the original image data respectively by using at least one convolution kernel one-to-one corresponding to the at least one direction, so as to obtain the feature data for the at least one direction.

According to embodiments of the present disclosure, the first processing module 910 is further used to: perform a filtering on the original image by using a median filter, so as to obtain the smooth image.

In the technical solution of the present disclosure, an acquisition, a storage, a use, a processing, a transmission, a provision and a disclosure of user personal information involved comply with provisions of relevant laws and regulations, and do not violate public order and good custom.

According to embodiments of the present disclosure, the present disclosure further provides an electronic device, a readable storage medium, and a computer program product.

FIG. 10 shows a block diagram of an electronic device for performing an image processing for implementing embodiments of the present disclosure.

FIG. 10 shows a schematic block diagram of an exemplary electronic device 1000 for implementing embodiments of the present disclosure. The electronic device 1000 is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and steps described above, such as the method of processing the image. For example, in some embodiments, the method of processing the image may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of processing the image described above. Alternatively, in other embodiments, the computing unit 1001 may be configured to perform the method of processing the image by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing an image, comprising:
performing a noise reduction on an original image to obtain a smooth image;
performing a feature extraction on the original image to obtain feature data for at least one direction; and
determining an image quality of the original image according to the original image, the smooth image, and the feature data for the at least one direction.

2. The method of claim 1, wherein the determining an image quality of the original image according to the original image, the smooth image, and the feature data for the at least one direction comprises:
determining, for a current pixel in the original image, a pixel difference value between the current pixel and a corresponding pixel in the smooth image;
determining target feature data for the current pixel from the feature data for the at least one direction; and
determining the image quality of the original image according to the pixel difference value and the target feature data.

3. The method of claim 2, wherein the feature data for the at least one direction comprises a plurality of feature images for a plurality of directions;
wherein the determining target feature data for the current pixel from the feature data for the at least one direction comprises:
determining a target feature image for one direction from the plurality of feature images for the plurality of directions; and
determining a pixel value of a target pixel corresponding to the current pixel in the target feature image as the target feature data for the current pixel.

4. The method of claim 3, wherein the determining a target feature image for one direction from the plurality of feature images for the plurality of directions comprises:
determining, from the plurality of feature images for the plurality of directions, a plurality of candidate pixels corresponding to the current pixel, wherein the plurality of candidate pixels one-to-one correspond to the plurality of feature images for the plurality of directions;
determining a candidate pixel with a smallest pixel value from the plurality of candidate pixels; and
determining a feature image corresponding to the candidate pixel with the smallest pixel value as the target feature image.

5. The method of claim 2, wherein the target feature data comprises a pixel value of a target pixel; and the determining the image quality of the original image according to the pixel difference value and the target feature data comprises:
determining the current pixel as a noise point, in response to determining that the pixel difference value is greater than a first threshold value and the pixel value of the target pixel is greater than a second threshold value; and
determining the image quality of the original image according to a number of noise points of the original image.

6. The method of claim 5, wherein the determining the image quality of the original image according to a number of noise points of the original image comprises:
determining a ratio of the number of noise points of the original image to a total number of pixels of the original image; and
determining the image quality of the original image according to the ratio.

7. The method of claim 1, wherein the performing a feature extraction on the original image to obtain feature data for at least one direction comprises:
performing a convolution on the original image data respectively by using at least one convolution kernel one-to-one corresponding to the at least one direction, so as to obtain the feature data for the at least one direction.

8. The method of claim 1, wherein the performing a noise reduction on an original image to obtain a smooth image comprises:
performing a filtering on the original image by using a median filter, so as to obtain the smooth image.

9. An electronic device, comprising:
at least one processor; and
a memory communicatively connected to the at least one processor, wherein the memory stores instructions executable by the at least one processor, and the instructions, when executed by the at least one processor, cause the at least one processor to implement a
method of processing an image, comprising operations of:
performing a noise reduction on an original image to obtain a smooth image;
performing a feature extraction on the original image to obtain feature data for at least one direction; and
determining an image quality of the original image according to the original image, the smooth image, and the feature data for the at least one direction.

10. The electronic device of claim 9, wherein the instructions, when executed by the at least one processor, cause the processor to further implement operations of:
determining, for a current pixel in the original image, a pixel difference value between the current pixel and a corresponding pixel in the smooth image;
determining target feature data for the current pixel from the feature data for the at least one direction; and
determining the image quality of the original image according to the pixel difference value and the target feature data.

11. The electronic device of claim 10, wherein the feature data for the at least one direction comprises a plurality of feature images for a plurality of directions;
wherein the instructions, when executed by the at least one processor, cause the processor to further implement operations of:
determining a target feature image for one direction from the plurality of feature images for the plurality of directions; and
determining a pixel value of a target pixel corresponding to the current pixel in the target feature image as the target feature data for the current pixel.

12. The electronic device of claim 11, wherein the instructions, when executed by the at least one processor, cause the processor to further implement operations of:
determining, from the plurality of feature images for the plurality of directions, a plurality of candidate pixels corresponding to the current pixel, wherein the plurality of candidate pixels one-to-one correspond to the plurality of feature images for the plurality of directions;
determining a candidate pixel with a smallest pixel value from the plurality of candidate pixels; and
determining a feature image corresponding to the candidate pixel with the smallest pixel value as the target feature image.

13. The electronic device of claim 10, wherein the target feature data comprises a pixel value of a target pixel; and wherein the instructions, when executed by the at least one processor, cause the processor to further implement operations of:
determining the current pixel as a noise point, in response to determining that the pixel difference value is greater than a first threshold value and the pixel value of the target pixel is greater than a second threshold value; and
determining the image quality of the original image according to a number of noise points of the original image.

14. The electronic device of claim 13, wherein the instructions, when executed by the at least one processor, cause the processor to further implement operations of:
determining a ratio of the number of noise points of the original image to a total number of pixels of the original image; and
determining the image quality of the original image according to the ratio.

15. The electronic device of claim 9, wherein the instructions, when executed by the at least one processor, cause the processor to further implement an operation of:
performing a convolution on the original image data respectively by using at least one convolution kernel one-to-one corresponding to the at least one direction, so as to obtain the feature data for the at least one direction.

16. The electronic device of claim 9, wherein the instructions, when executed by the at least one processor, cause the processor to further implement operation of:
performing a filtering on the original image by using a median filter, so as to obtain the smooth image.

17. A non-transitory computer-readable storage medium having computer instructions therein, wherein the computer instructions are configured to cause a computer to implement a method of processing an image, comprising operations of:
performing a noise reduction on an original image to obtain a smooth image;
performing a feature extraction on the original image to obtain feature data for at least one direction; and
determining an image quality of the original image according to the original image, the smooth image, and the feature data for the at least one direction.

18. The storage medium of claim 17, wherein the computer instructions are configured to cause the computer further to implement operations of:
determining, for a current pixel in the original image, a pixel difference value between the current pixel and a corresponding pixel in the smooth image;
determining target feature data for the current pixel from the feature data for the at least one direction; and
determining the image quality of the original image according to the pixel difference value and the target feature data.

19. The storage medium of claim 18, wherein the feature data for the at least one direction comprises a plurality of feature images for a plurality of directions;
wherein the computer instructions are configured to cause the computer further to implement operations of:
determining a target feature image for one direction from the plurality of feature images for the plurality of directions; and
determining a pixel value of a target pixel corresponding to the current pixel in the target feature image as the target feature data for the current pixel.

20. The storage medium of claim 19, wherein the computer instructions are configured to cause the computer further to implement operations of:
determining, from the plurality of feature images for the plurality of directions, a plurality of candidate pixels corresponding to the current pixel, wherein the plurality of candidate pixels one-to-one correspond to the plurality of feature images for the plurality of directions;
determining a candidate pixel with a smallest pixel value from the plurality of candidate pixels; and
determining a feature image corresponding to the candidate pixel with the smallest pixel value as the target feature image.
